(19) United States
(12) Patent Application Publication
(10) Pub. No.: US 2025/0355490 A1
(43) Pub. Date: Nov. 20, 2025

(54) Computer Vision Based Algorithm For Enabling Communication Based On Patterns Of Blinks For Full Body Disabled Paitients

(71) Applicant: Grace Alexander Iordanov, Redmond, WA (US)

(72) Inventor: Grace Alexander Iordanov, Redmond, WA (US)

(73) Assignee: Grace Alexander Iordanov, Redmond, WA (US)

(21) Appl. No.: 19/037,194

(22) Filed: Mar. 1, 2025

(51) Int. Cl. G06F 3/01; G06F 3/0482; G10L 13/04

(52) U.S. Cl. CPC G06F 3/013; G06F 3/0482; G10L 13/04

(57) ABSTRACT

The present invention relates to a software program that is made for allowing people with full body paralysis to communicate through patterns of blinks. The device includes a GUI which displays the camera view facing toward the user, a mesh sequence on the users face to confirm detection of it, and phrases listed on the upper left hand side of the screen with the number of blinks correlating to the phrase. On the backend the software includes a program loop in which all instructions in the program and executed in, a convolutional algorithm for detecting on an FPS basis different parts of the face such as the eyes, ears, nose, and mouth, an algorithm for determining the eye movement sequence eyeblink and an algorithm for counting and matching the number of eyeblinks detected to its phrase and outputting it in the GUI and through audio.

### BACKGROUND OF THE INVENTION

The present invention relates to the field of assistive computer vision technologies, and more specifically, to an advanced system for communicating through patterns of eye blinks using real time computer vision infrastructure for detecting and capturing certain patterns of blinks.

The system consists of an algorithm with a GUI that in real time detects when the patient blinks and counts the number of times that they blink. A key feature of the invention is portability and low cost in comparison with other hardware based alternatives.

Several inventions have attempted to address the problem of providing more interactive care to fully body disabled people but they do not address the issue of using the blinking motion they detect for communication with another human standing next to them.

EU Patent No. EP31407191B (Doe, 2017) discloses a software system that allows the user to interact with a graphical user interface operating system using eye movements.

The limitations of this invention is that it is primarily meant for communicating with a computer through using an assistive based GUI but not directly to a human next to them. The system also does not use a simple easy to remember language for the communication process and either relying on multiple types of eye movements that can be time consuming to produce. Being able to use this kind of technology to achieve the exact purpose of communicating with a human right next to them to communicate with translatable language that could be understood any the bystander would be very challenging and time consuming.

U.S. patent application Ser. No. 12/199,693 (William et. Torch et al., 2016) discloses a system for monitoring a persons eye movement for detecting drowsiness through utilizing a system includes a frame that is worn on a person's head, emitters on the frame that direct light towards the person's eye, and an array of sensors on the frame for detecting light from the array of emitters. The sensors detect any light which is reflected off of certain sections of the eye or eyelid which create signals that indicate when certain portions of the eye is covered by the eyelid.

The limitations of this invention is that while this technology provides a great way for being able to track the blinking movements of somebody without a device next to them it does not provide an ability to communicate with certain patterns of eyeblinks which the patient might emit. In low light settings this device may also be ineffective with a sole ability of measuring a blink by light reflected off of a person's eye. My invention on the other hand can be used in low light settings with an Infared camera that can detect with heatmaps the EAR ratio of the eyes.

The present invention provides significant advancements over the prior art by specifically targeting communication to other humans rather than to the device through audio output. Unlike the software for blinking based navigation on a computer described in Doe's U.S. Pat. No. 9,654,321, which aims to provide a medium of communication between disabled patients and a computer, the present invention aims to provide a way for the patient to communicate to other humans right next to them by using the computer as a way to contextualize and output the phrases used.

### SUMMARY OF THE INVENTION

The present invention relates to a computer vision based software program that detects patterns of blinking and correlates them to certain phrases which are output on a GUI and through audio. The system consists of GUI for displaying the camera view of the person, the phrases that correlate to a certain number of blinks, and the face mesh produced by the computer vision program for detecting the users face, and the current phrase that has been output from a pattern of blinks, a program loop for running the functionality of the program including detecting coordinates of different parts of the face and detecting when a person blinks on a frames per second basis.

The program loop runs the algorithm for detecting the coordinates of certain parts of the face such as the eyes, nose and mouth, and displaying a mesh result on the GUI on their detection. There is also a subaortic for detecting what movements of the coordinates that make up the current positions of the eyes correlates to a blink.

A key feature of this invention is to be able to consistently detect and count up the number of blinks while the app is running within an 18 second time interval to give the user enough time to be able to make a sequence of blinks up to 10 until the result is automatically output on the GUI and through audio and then erase it for the next interval. The app is also able to detect blinks which are made with limited movement of the muscles around the eyes for easy use of the app.

### BRIEF DESCRIPTION OF THE DRAWINGS

FIG. 1. Depicts the design of the GUI including the text and the outline of the users face showing the mesh outline of the face

FIG. 2. Depicts the functionality and structure of the algorithm and its interaction with the GUI

FIG. 3. Depicts the dataflow process of the algorithm for processing the number of blinks made during a time interval

### DETAILED DESCRIPTION

The present invention relates to the field of assistive technologies, and more particularly, to a computer vision based system to provide support to paitients with full or upper body paralysis who are unable to communicate.

Current technologies available for allowing people with locked in syndrome to communicate are either too invasive, or too expensive to use. My invention addresses this through using a fully software based approach to solve this problem that only requires a computer and a camera to use.

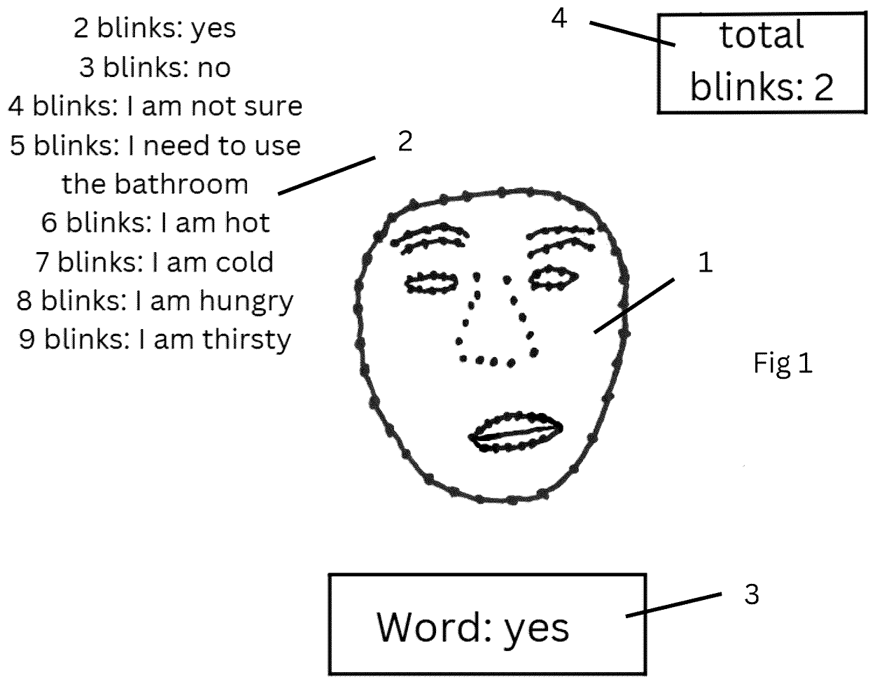

As shown in FIG. 1 in component 1 the mesh face outline of the users face, in component 2 the guide to the different available phrases to output, component 3 which is the label for the most recent phrase and output to component 4 a label that shows the most recent number of blinks that were made during the current interval.

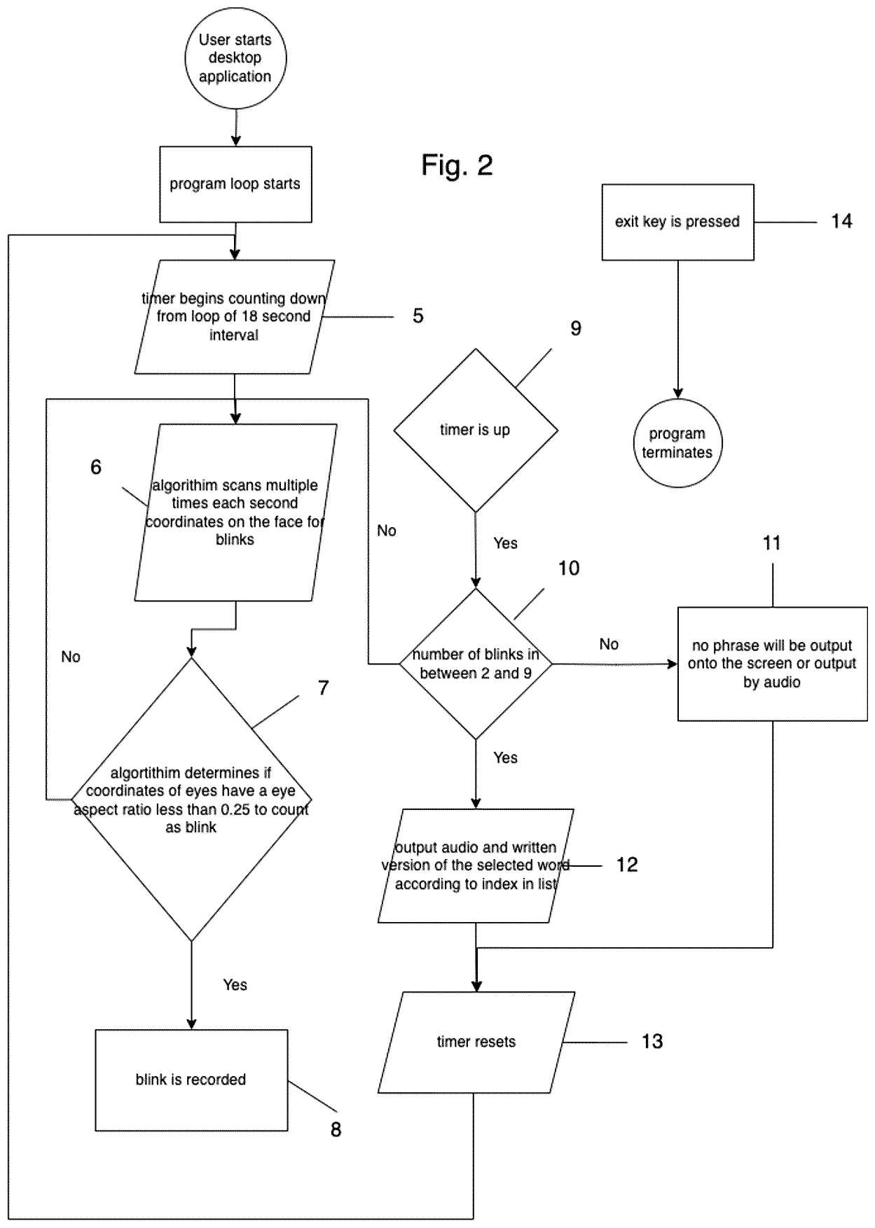

As shown in FIG. 2. The process begins at component 5 where the timer begins counting down the 18 second interval, the next part in the process is component 6 where the algorithm scans the face several times per second to detect coordinates to check for blinks, the third step in the process is component 7 where the algorithm checks for the EAR ratio to be less than 0.25 to count eye movement as blink, if the ratio is less than 0.25, fourth step in the process is component 8 where the blink is recorded, component 8 represents the method of when the phrase determined by the number of blinks is output onto the screen

component 9 represents the beginning of the process that to output the text where the interval is over after 18 seconds, the second step is component 10 where if the number of blinks is checked if its between 2 and 9 if it is not the process will continue to component 11 where the text output process will abort and circle back to component 6 if the condition is true for component 10 the phrase correlating to the index of the list containing then the phrases will be output onto the screen and by audio in component 12, when this is complete in component 13 the timer resets and the interval starts from the beginning

component 14 represents the final component of the program where if at any time when using the program the x button, the program will terminate.

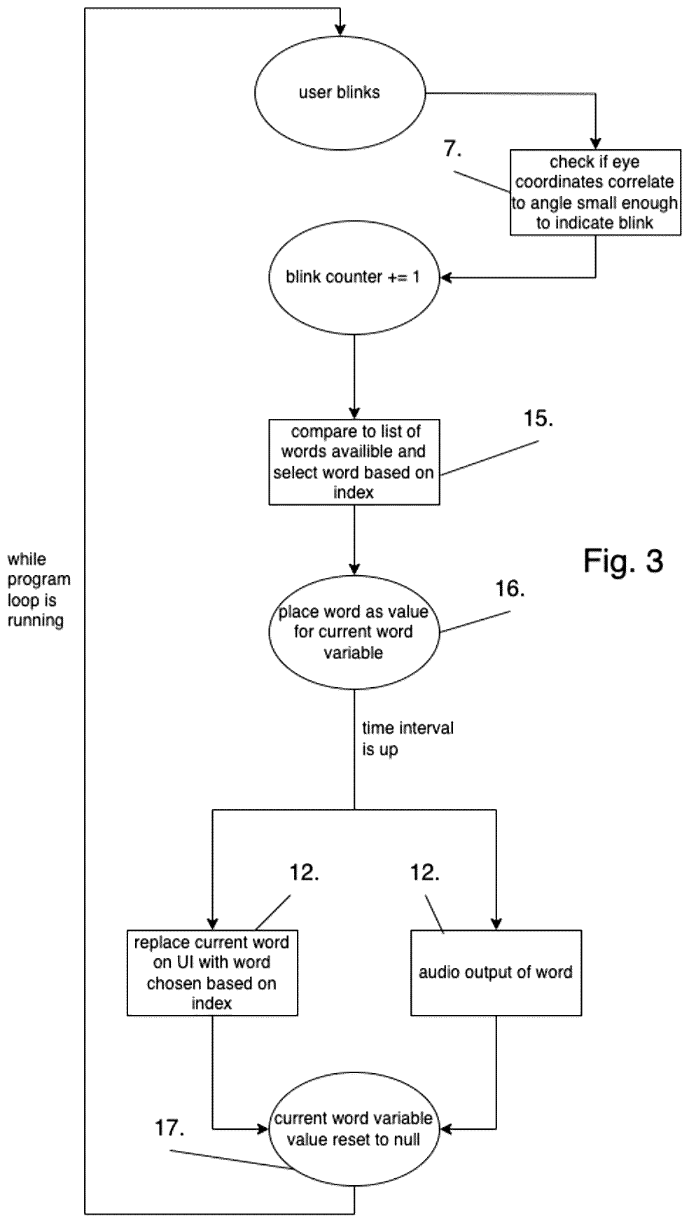

As shown in FIG. 3. the first component in this process is step 7 where the eye aspect ratio is checked if it is bellow 0.25, the word in list is selected based on its index in component 15, in component 16 the word is placed as the value for the variable of the chosen phrase, in component 12 where the phrase is output in audio and is output onto the GUI the final step in this process is component 17 where the value for the variable representing the current phrase is set to null

This invention is a computer vision based software that monitors when the user blinks and outputs certain phrases such as “I am hungry” or “I am hot” depending on different patterns of eye links the user makes. The software uses the libraries of sci py, mediapipe, and openCV for monitoring, detecting and tracking the patterns of eyeblinks the user may make The software can be used on a comparable laptop or tablet which can be placed roughly 4 inches away from the face of the patient.

Description of the Preferred Embodiments The following description provides detailed embodiments of the invention, but it should be understood that the invention is not limited to these embodiments.

The scope of the invention is defined by the claims:

1. Device Structure: The assistive technology for allowing communication through blinking includes: A program loop this element contains the main ability to allow the program to function it is made up of a real time convolutional processing algorithm, A feedback loop which outputs an audio sequence mentioning the selected phrase.

This contains multiple sub algorithms including an eye openness degree measurement system, for measuring whether the eye of the user is sufficiently closed for it to be counted as a blink. A word matching system, for counting the number of blinks recorded and correlating them to the correct word when the 18 second time interval is up. (former space)

2. Interaction With the Invention: Interaction with this invention is soley made through sequences of eyeblinks which the invention detects and processes for a result dependent on their quantity. Eyeblinks are measured by coordinates detected by the mediapipe algorithm which correlate to the degree of eye openness.

If the degree of eye openness is bellow the value of 2.3 the eye movement is recorded as a blink. If the movement has a degree greater than 2.3 than the movement is not recorded as a blink. This level of openness is sensitive enough to allow patients using the app to not need to blink very abruptly to be able to use the app. The monitor should be placed roughly 4 inches away from the users face in order to be able to achieve the highest accuracy with detecting the blinks. The invention also should be used in a well lit room with the user stationed in a position with minimal noise to disrupt detection of the blinks.

3. User Feedback: Feedback to the user comes in the form of an audio response and a textual output in the GUI. The textual output remans on the screen for the next 18 seconds until the next phrase determined by the quantity of blinks is created. From the moment the app is opened a recurring 18 second interval timer begins and counts the number of blinks correlating to a certain phrase during that time.

Once the time is up the amount of blinks the user made during this time period are tallied up matched to the phrase correlating to the quantity. Once the word is output onto the screen and output in audio form the user can start the next sequence of blinks for the next phrase. The app is deactivated by the X button being pressed on the program window by a bystander

1. A computer vision algorithm for counting the number of blinks the user makes comprising:
a method for determining whether or not the user blinked;
a program loop that runs for 18 second intervals until the program is shut down;
and a module for outputting the chosen phrase in audio and in text onto the GUI.

2. The computer vision algorithm of claim one where blinks are detected based on the value of the eye aspect ratio.

3. The computer vision algorithm of claim one where the number of detected blinks is matched to a specific word or phrase from a list of 9 different phrases available.

4. The computer vision algorithm of claim one where any consecutive blinks the user makes are added up for 18 second intervals.

5. The computer vision algorithm of claim one where the 18 second interval that the user can make blinks during restarts after finished until the software is exited.

6. The computer vision algorithm of claim one which outputs in audio context the chosen phrase after the interval is over.

7. The computer vision algorithm of claim one where the number of blinks made during the last 18 second interval is reset to 0 on the start of the new interval.

8. The computer vision algorithm of claim one which uses the coordinates detected of the position of the users eyes to determine the eye aspect ratio.

9. A GUI display comprising:
a mesh outline of the users face;
a label displaying the options for phrases to output;
a label displaying the number of blinks the user has made during the interval;
and a label displaying the current word output determined by the number of blinks made during the interval.

10. The GUI of claim nine which displays the current amount of blinks made within the 18 second interval on the screen.

11. The GUI of claim nine which displays the list of available phrases for the user to choose from to output.

12. The GUI of claim nine which displays the current piece of text in correlation to the number of blinks onto the screen after the 18 second interval is over.

13. The GUI of claim nine which depicts an outline of the users face that color codes all facial features detected.

14. The GUI of claim nine which depicts the camera view facing the user.
